(19) United States
(12) Patent Application Publication
(10) Pub. No.: US 2003/0079007 A1
(43) Pub. Date: Apr. 24, 2003

(54) Redundant source event log

(76) Inventor: Cynthia M. Merkin, Georgetown, TX (US)

Correspondence Address: HAMILTON & TERRILE, LLP, P.O. Box 203518, Austin, TX, 78720, US

(21) Appl. No.: 10/027,618

(22) Filed: Oct. 22, 2001

(51) Int. Cl. G06F 15/173; G06F 15/16

(52) U.S. Cl. 709/223; 709/251

(57) ABSTRACT

A method and system for accessing and writing event data to a log on failure of a computer system that is independent of the computer system's operating system. On the occurrence of a failure event in the computer system, a Basic Input Output System (BIOS) program is executed to write data to an event data log describing the failure. A system management controller that is included in the computer system, is configured to receive an indication of the failure. In response to the failure, the system controller initiates an operation of the timer to determine whether the BIOS program has completed execution prior to the expiration of the timer. If the BIOS program fails to complete prior to the expiration of the timer, the system controller accesses and writes data to the event data log.

### BACKGROUND OF THE INVENTION

1. Field of the Invention

The present invention relates to the field of computer systems. More specifically, the present invention relates to an operating system independent technique for accessing and writing event log data on failure of a computer system.

2. Description of the Related Art

Personal computer (“PC”) systems in general and IBM compatible computer systems in particular have attained widespread use. These computer systems, which are also referred to as PC systems, handle information and primarily give independent computing power to a single user (or a relatively small group of users in the case of a computer system network). Such computer systems are generally inexpensively priced for purchase by individuals or small businesses and provide computing power to many segments of today's modern society. It is also well known that such computer systems may be coupled to one or more computer networks to create a distributed computing architecture.

A computer system can usually be defined as a desktop, floor-standing, or portable microcomputer that includes a system unit having a central processing unit (“CPU” or a “processor”), volatile and/or non-volatile memory, a display monitor, a keyboard, one or more floppy diskette drives, a hard disk storage device, an optional DVD or CD-ROM drive, and an optional printer. A computer system also includes an operating system, such as Microsoft Windows XP™ or Linux. A computer system may also include one or a plurality of peripheral devices such as input/output (“I/O”) devices coupled to the system processor via one or more buses to perform specialized functions. Examples of buses include peripheral component interconnect (“PCI”) bus and industry standard architecture (“ISA”) bus. Examples of I/O devices include keyboard interfaces with keyboard controllers, floppy diskette drive controllers, modems, sound and video devices, specialized communication devices, and even other computer systems communicating with each other via a network. These I/O devices are typically plugged into connectors of computer system I/O interfaces such as serial interfaces and parallel interfaces. Generally, these computer systems use a system board or motherboard to electrically interconnect these devices.

Computer systems also typically include basic input/output system (“BIOS”) programs to ease programmer/user interaction with the computer system devices. More specifically, BIOS provides a software interface between the system hardware and the operating system/application program. The operating system (“OS”) and application program typically access BIOS rather than directly manipulating I/O ports, registers, and control words of the specific system hardware. Well known device drivers and interrupt handlers access BIOS to, for example, facilitate I/O data transfer between peripheral devices and the OS, application program, and data storage elements. BIOS is accessed through an interface of software interrupts and contains a plurality of entry points corresponding respectively to the different interrupts. In operation, BIOS is typically loaded from a BIOS ROM or BIOS EPROM, where it is nonvolatily stored, to main memory from which it is executed. This practice is referred to as “shadowing” or “shadow RAM” and increases the speed at which BIOS executes.

Although the processor provides the “kernel” of the computer system, I/O communication between an I/O device and the CPU forms a basic feature of computer systems. Many I/O devices include specialized hardware working in conjunction with OS specific device drivers and BIOS routines to perform functions such as information transfer between the processor and external devices, such as networks, modems and printers, coupled to I/O devices.

Distributed Management Task Force, Inc. (“DMTF”) is a not-for-profit association of industry members dedicated to promoting enterprise and systems management and interoperability. The term “system management” represents a wide range of technologies that enable remote system access and control in both OS-present and OS-absent environments. These technologies are primarily focused on minimizing on-site information technology (“IT”) maintenance, maximizing system availability and performance to the local user, maximizing remote visibility of (and access to) local systems by IT managers and minimizing the system power consumption required to keep this remote connection intact. An Alert Standard Format (“ASF”) Specification, Version 1.03, dated Jun. 20, 2001, published by DMTF, which is hereby incorporated as a reference, describes remote control and alerting interfaces for the clients' OS-absent environments in a client/server environment. Various types of failures of the client computer system are described in the ASF specification.

Sensors, diagnostic tests or other well-known methods typically detect critical computer system failures, such as a memory failure. The failure typically results in the generation of a system management interrupt (“SMI”) signal. The SMI typically places the computer system in a system management mode (“SMM”) of operation. The processor generally saves status registers and/or context settings associated with the current task in memory. When a resume instruction is executed in the SMM, the processor restores the context settings of the previous task being executed prior to the SMI.

A SMI handler typically handles the SMI interrupt condition. In order to determine a probable cause for the failure and write an event log to memory to document the system failure, the SMI handler may execute a BIOS program to access memory locations storing failure data. Memory may include a set of registers, e.g., PCI configuration registers, or other similar memory locations, which store data associated with the computer system failure. However, the execution of the BIOS program to access memory often results in a duplication or re-creation of the failure sequence that triggered the SMI. The double failure condition often results in halting the computer system, and thereby prevents access to the failure event log data.

What is needed is an operating system independent technique for accessing and writing event log data on failure of a computer system, preferably providing a redundant or an alternate path to the source event log data.

### SUMMARY OF THE INVENTION

In accordance with the present invention, a method and system thereof for accessing and writing event data to a log on failure of a computer system that is independent of the computer system's operating system is described.

In one embodiment, a system management controller that is included in a computer system is used to implement a method of accessing event data describing a failure of the computer system. The method includes configuring the system management controller to monitor a task of writing data to an event log. A Basic Input Output System (BIOS) program is configured to execute the task in response to the failure. The system management controller monitors the task for completion. In one embodiment, the monitoring of the task is accomplished by setting up a configurable timer included in the system management controller and determining whether the task is completed prior to the expiration of the timer. If it is determined that the task is not complete prior to the expiration of the timer, the system management controller accesses and writes the event data to the log.

In one embodiment, a method of accessing event data on a failure of a computer system includes executing a BIOS program to access the event data in response to a first failure of the computer system. A watchdog timer in a system management controller of the computer system is triggered substantially concurrent to the occurrence of the first failure. The watchdog timer is configured to allow the BIOS program to complete in absence of a second failure. The system management controller determines whether the execution of the BIOS program caused the second failure. The occurrence of the second failure forces the watchdog timer to expire. The system management controller accesses and writes the event data when the watchdog timer expires.

In one embodiment, a computer system includes a processor, a memory coupled to the processor, a BIOS program stored in the memory, and a system controller coupled to the memory and the processor. The BIOS program writes data to an event log in response to a critical event such as a failure in the computer system. The system controller is operable to receive an indication of the critical event. Upon receipt of the indication, the system controller initiates operation of a timer; and determines whether the BIOS program has written the data to the event log within a configurable period of time defined by the timer.

In one embodiment, a method of responding to an event may be implemented in a computer system having a processor and a system controller. The method includes issuing an interrupt to the processor in response to the event, such as a failure in the computer system. The system controller detects the interrupt at the system controller coupled to the processor, and initiates a timer in the system controller in response to the detection of the interrupt. A BIOS program is executed to attempt to write data to an event log. The system controller determines whether the execution of the BIOS program resulted in writing data to the event log.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a computer system for accessing and writing event log data on failure of the computer system in accordance with the present invention;

FIG. 2 shows one embodiment of a flow chart for a method of accessing event data describing a failure of the computer system;

FIG. 3 shows another embodiment of a flow chart for a method of accessing event data describing a failure of the computer system; and

FIG. 4 illustrates a flow chart for a method of responding to an event associated with the computer system.

### DETAILED DESCRIPTION

For a thorough understanding of the subject invention, including the best mode contemplated by the inventor for practicing the invention, reference may be had to the following Detailed Description, including the appended Claims, in connection with the above-described Drawings. The following Detailed Description of the invention is intended to be illustrative only and not limiting.

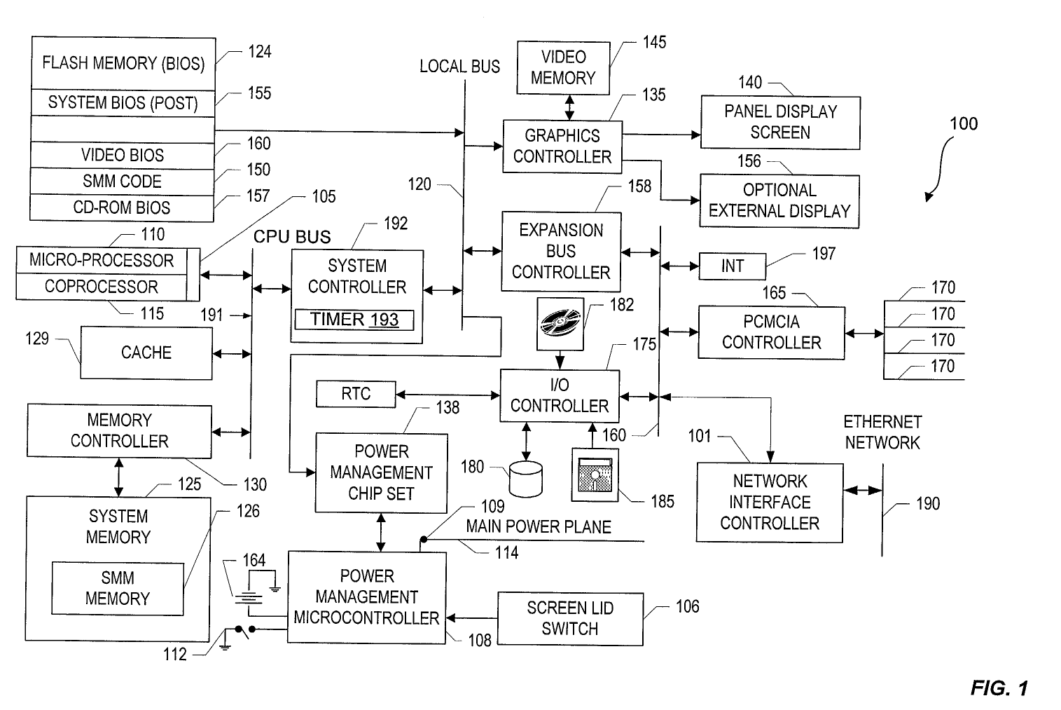

Referring to FIG. 1, a computer system 100 is shown that is suitable for implementing an operating system independent method of accessing and writing event log data on a failure of the computer system 100. In one embodiment, the implementation is based on using hardware and/or firmware devices described below, and is thus independent of the operating system of the computer system 100. The computer system 100 includes a processor (“processor”) 105, for example, an Intel Pentium™ class microprocessor or an AMD Athlon™ class microprocessor, having a micro-processor 110 for handling integer operations and a coprocessor 115 for handling floating point operations. Processor 105 is coupled to cache 129 and memory controller 130 via processor bus 191.

A main memory 125 of dynamic random access memory (“DRAM”) modules is coupled to local bus 120 by a memory controller 130. Main memory 125 includes a system management mode (“SMM”) memory area that is employed to store code to implement various embodiments as will be discussed in more detail subsequently.

In a simple form, a computer system 100 may include a processor 105 and a memory 125. The processor 105 is typically enabled to execute instructions stored in the memory 125. The executed instructions typically perform a function. Computer systems may vary in size, shape, performance, functionality and price. Examples of a computer system 100, which include a processor 105 and memory 125, may include all types of computing devices within the range from a pager to a mainframe computer.

A (BIOS) memory 124 is coupled to local bus 120. A FLASH memory or other nonvolatile memory is used as BIOS memory 124. A BIOS program (not shown) is usually stored in the BIOS memory 124. The BIOS program includes CD-ROM BIOS 157 software for interaction with the computer system boot devices such as the CD-ROM 182. The BIOS memory 124 stores the system code that controls some computer system 100 operations.

A graphics controller 135 is coupled to local bus 120 and to a panel display screen 140. Graphics controller 135 is also coupled to a video memory 145 which stores information to be displayed on panel display 140. Panel display 140 is typically an active matrix or passive matrix liquid crystal display (“LCD”) although other display technologies may be used as well. Graphics controller 135 can also be coupled to an optional external display or standalone monitor display. One graphics controller that can be employed as graphics controller 135 is the Western Digital WD90C14A graphics controller.

A bus interface controller or expansion bus controller 158 couples local bus 120 to an expansion bus 160. In this particular embodiment, expansion bus 160 is an Industry Standard Architecture (“ISA”) bus although other buses, for example, a Peripheral Component Interconnect (“PCI”) bus, could also be used. A personal computer memory card international association (“PCMCIA”) controller 165 is also coupled to expansion bus 160 as shown. PCMCIA controller 165 is coupled to a plurality of expansion slots 170 to receive PCMCIA expansion cards such as modems, fax cards, communications cards, and other input/output devices. Interrupt request generator 197 is also coupled to ISA bus 160 and issues an interrupt service request over a predetermined interrupt request line after receiving a request to issue interrupt instruction from processor 105.

An I/O controller 175, often referred to as a super I/O controller is coupled to ISA bus 160. I/O controller 175 interfaces to an integrated drive electronics (“IDE”) hard drive 180, a CD-ROM drive 182 and a floppy drive 185. An optional network interface controller 101 enables the computer system 100 to communicate with a computer network such as an Ethernet 190. The computer network may include a network such as a local area network (“LAN”), wide area network (“WAN”), Internet, Intranet, wireless broadband or the like. The network interface controller 101 forms a network interface for communicating with other computer systems (not shown) connected to the Ethernet 190 for implementing a method of accessing failure event log data of the computer system. The computer system's networking components generally include hardware as well as software components. Examples of the hardware components include the network interface controller 101 and the Ethernet 190. Examples of the software components, which include messaging services and network administration services, are described below.

The computer system 100 serves as a controller for resolving proprietary and standard event and message structures into a common format for use by the computer network for many management purposes. The computer system 100 is connected with a plurality of computer systems in the network for receiving messages from the computer systems, analyzing the messages and determine an effective utilization of the messages as directed by a user or network administrator. The computer system 100 receives messages in different message formats, organizes the messages, and converts the messages into a common format that assists a user, system administrator, or network administrator in utilizing the information contained in the messages. The converted messages in a common format are distributed at the discretion of a user, network administrator, or system administrator based on user needs or message importance to other system administration applications via a selected communication method. The network administrator controls the type of messages that are communicated over the network. The computer system 100 supports the conversion of messages into the common format to facilitate particular network applications.

Computer system 100 includes a power supply 164, for example, a battery, which provides power to the many devices which form computer system 100. Power supply 164 is typically a rechargeable battery, such as a nickel metal hydride (“NiMH”) or lithium ion battery, when computer system 100 is embodied as a portable or notebook computer. Power supply 164 is coupled to a power management microcontroller 108 which controls the distribution of power from power supply 164. More specifically, microcontroller 108 includes a power output 109 coupled to the main power plane 114 which supplies power to processor 105. Power microcontroller 108 is also coupled to a power plane (not shown) which supplies power to panel display 140. In this particular embodiment, power control microcontroller 108 is a Motorola 6805 microcontroller. Microcontroller 108 monitors the charge level of power supply 164 to determine when to charge and when not to charge battery 164. Microcontroller 108 is coupled to a main power switch 111 which the user actuates to turn the computer system 100 on and off. While microcontroller 108 powers down other portions of computer system 100 such as hard drive 180 when not in use to conserve power, microcontroller 108 itself is always coupled to a source of energy, namely power supply 164.

In a portable embodiment, computer system 100 also includes a screen lid switch 106 or indicator 106 which provides an indication of when panel display 140 is in the open position and an indication of when panel display 140 is in the closed position. It is noted that panel display 140 is generally located in the same location in the lid of the computer as is typical for “clamshell” types of portable computers such as laptop or notebook computers. In this manner, the display screen forms an integral part of the lid of the computer that swings from an open position for interaction with the user to a closed position.

Computer system 100 also includes a power management chip set 138, which includes power management chip models PT86C511 and PT86C511 manufactured by Pico Power. Power management chip set 138 is coupled to processor 105 via local bus 120 so that power management chip set 138 can receive power control commands from processor 105. Power management chip set 138 is connected to a plurality of individual power planes which supply power to respective devices in computer system 100 such as hard drive 180 and floppy drive 185, for example. In this manner, power management chip set 138 acts under the direction of processor 105 to control the power to the various power planes and devices of the computer. A real time clock (“RTC”) 140 is coupled to I/O controller 175 and power management chip set 138 such that time events or alarms can be transmitted to power management chip set 138. Real time clock 140 can be programmed to generate an alarm signal at a predetermined time.

When computer system 100 is turned on or powered up, the computer system 100 enters a start up phase, also referred to as a boot up phase, during which the computer system hardware is detected and the operating system is loaded. In case of a computer system 100 with the Windows NT operating system, the boot up process is typically divided into multiple stages. The initial boot stages pertain to start up of the system components of the computer system 100 and the later boot stage typically pertains to the boot up of networking components of the computer system 100.

During the initial boot stages, the computer system BIOS software stored in nonvolatile BIOS memory 124 is copied into main memory 125 so that it can be executed more quickly. This technique is referred to as “shadowing” or “shadow RAM” as discussed above. At this time, system management mode (“SMM”) code 150 is copied into the system management mode memory area 126 of main memory 125. Processor 105 executes SMM code 150 after processor 105 receives a system management interrupt (“SMI”) which causes the processor 105 to enter SMM mode. Additional conditions under which an SMI is generated are discussed subsequently. It is noted that along with SMM code 150, also stored in BIOS memory 124 and copied into main memory 125 at power up are system BIOS 155 (including a power on self test module-POST), CD-ROM BIOS 157 and video BIOS 160. It will be recognized by those of ordinary skill in the art that other memory mapping schemes may be used. For example, SMM code 150 may be stored in fast SRAM memory (not shown) coupled to the local/processor bus 120. In one embodiment, computer system 100 may be a server. The computer system 100 may be configured as a server to manage network resources. As is well known, several types of server configurations may be possible. For example, the computer system may be set up as a file server dedicated to storing files. A client user on the network may store files on the server. Other examples of servers include a print server, a web server and a database server. One example of a computer system 100 in a server configuration is the PowerEdge™ 6400 server manufactured by Dell Computer Corporation.

System controller 192, also referred to as a system management controller, couples processor bus 191 to local bus 120. An event, such as a failure of the computer system 100, typically generates a system management interrupt. An abnormal operation of the computer system 100 may be described as a failure. The impact of a failure on the availability of the computer system 100 may vary depending on the type of the failure. A critical failure may be defined as a failure in computer system's hardware and/or firmware. The occurrence of a critical failure may be defined as a critical event. A recovery from a critical failure typically requires a reboot operation.

In response to the system management interrupt, a task included in the BIOS program stored in BIOS memory 124 is triggered. In one embodiment, the system management interrupt may execute the BIOS program stored in BIOS memory 124. The BIOS program (or the task in the BIOS program) is operable to access/read data describing the failure and write data to an event log describing the failure. In one embodiment, the data is stored in memory 125, e.g., PCI configuration registers. In this embodiment, the data accessed/read by the BIOS program is stored in the memory 125 by a controller device included in the computer system 100. In this embodiment, the data may be accessible via a system bus, e.g., a SMbus.

The controller device, e.g., memory controller 130 or a graphics controller 135, typically detects an event such as the failure of a component in the computer system. For example, the memory controller 130 typically detects a memory failure. The failure condition is latched and a processor 105 interrupt signal is generated. In one embodiment, system controller 192 is enabled to receive the same interrupt signal that causes the system management interrupt (“SMI”) signal to the processor 105. The timing of the system controller 192 receiving the interrupt signal and the processor 105 receiving the SMI is substantially concurrent.

System controller 192 may be configured to monitor whether the execution of the BIOS program (or the task included in the BIOS program) resulted in the writing of data to an event log on failure of the computer system 100. In one embodiment, inclusion of a timer 193, e.g., a watchdog timer, in the system controller 192 may enable monitoring of the BIOS program. The watchdog timer is operable to count down/up a configurable time period. The system controller 192 starts the timer 193 on receipt of the interrupt signal. In this embodiment, the timer 193 is configured to determine whether the BIOS program was executed to write data to the event log. If it was determined that the BIOS program was not able to write the data to the event log, e.g., when the BIOS program encounters a subsequent failure such as an occurrence of a second critical event, then the system controller is configured to respond to the second failure by writing the data to the event log. The execution of the BIOS program may result in a second failure, thereby preventing the BIOS program from being completed. In one embodiment, the second failure, e.g., caused by repeating the original failure sequence that caused the generation of the system management interrupt signal, is substantially similar to the first failure. In this embodiment, the second failure occurs while the processor 105 is in the SMM mode. The second failure forces the timer 193 to expire. The BIOS program may be configured to execute, e.g., be completed, within the configured time period. If the execution of the BIOS program is not completed within the configured time of the timer 193, a watchdog expiration signal may be sent to other devices within the computer system 100.

In one embodiment, the computer system 100 includes a computer-readable medium having a computer program or computer system 100 software accessible therefrom, the computer program including instructions for performing the method of enabling removal of a removable medium of a boot device included in a computer system when booting an embedded operating system. The computer-readable medium may typically include any of the following: a magnetic storage medium, including disk and tape storage medium; an optical storage medium, including compact disks such as CD-ROM, CD-RW, and DVD; a non-volatile memory storage medium; a volatile memory storage medium; and data transmission or communications medium including packets of electronic data, and electromagnetic or fiber optic waves modulated in accordance with the instructions.

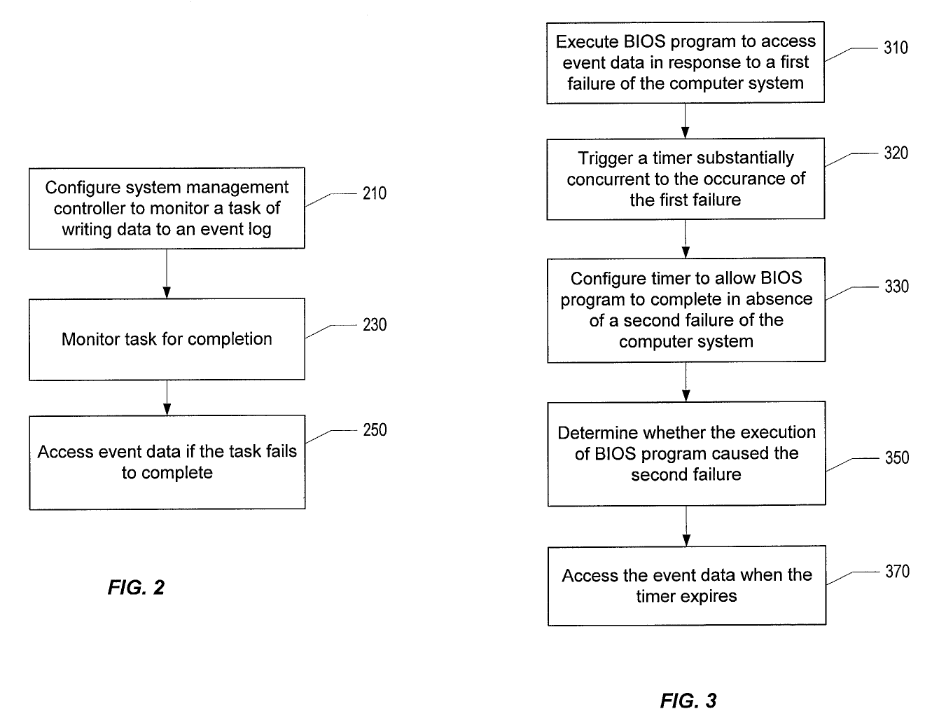

Referring to FIG. 2, a flow chart shows an embodiment of a method of accessing event data describing a failure of the computer system 100 illustrated in FIG. 1. In this embodiment, the method of accessing event data that describes a failure is implemented in the system controller 192. In step 210, the system controller 192 is configured to monitor a task of writing data to an event log. The task of writing data to the event log may be accomplished by executing a BIOS program. The BIOS program is executed in response to receiving the SMI interrupt signal that is generated in response to an occurrence of a critical event such as a hardware and/or firmware failure of the computer system 100.

In step 230, the task of writing data to the event log is monitored for completion. In one embodiment, monitoring the task for completion includes determining whether the BIOS program writes data to the event log within a configurable time period of the timer 193. In another embodiment, monitoring the task for completion described in this step includes setting a configurable time period of the timer 193. The task is configured to read or access the event data and write the data to the event log in response to reading or accessing the event data. The task is completed prior to the expiration of the timer 193. Monitoring the task for completion further includes receiving an indication from the BIOS program on completion of the task. The system controller 192 receives an indication from the BIOS program when it has successfully completed the task of writing data to the event log. In this embodiment, the indication may be represented by a signal received to reset the timer 193 prior to the expiration of the configurable time period.

In step 250, if the task fails to complete, e.g., the BIOS program is not able to write data to the event log prior to the expiration of the timer 193, then the system controller 192 accesses the event data.

Referring to FIG. 3, a flow chart shows another embodiment of a method of accessing event data describing a failure of the computer system 100 illustrated in FIG. 1. In this embodiment, a BIOS program is executed in response to a first failure of the computer system in step 310. The BIOS program is executable to access the event data. The timer 193 included in the system controller 192 is triggered in a manner which is substantially concurrent to the first failure, described earlier, in step 320. For example, the SMI interrupt may be used to trigger the timer 193. In step 330, the timer is configured to allow the BIOS program to complete in absence of the second failure, described earlier. In step 350, it is determined whether the execution of the BIOS program caused the second failure by determining whether the timer 193 has expired. In one embodiment, the second failure is substantially similar to the first failure. In this embodiment, the second failure occurs while processor 105 included in computer system 100 operates in a SMM mode. In step 360, if it determined that the timer 193 has expired then the system management controller accesses the event data.

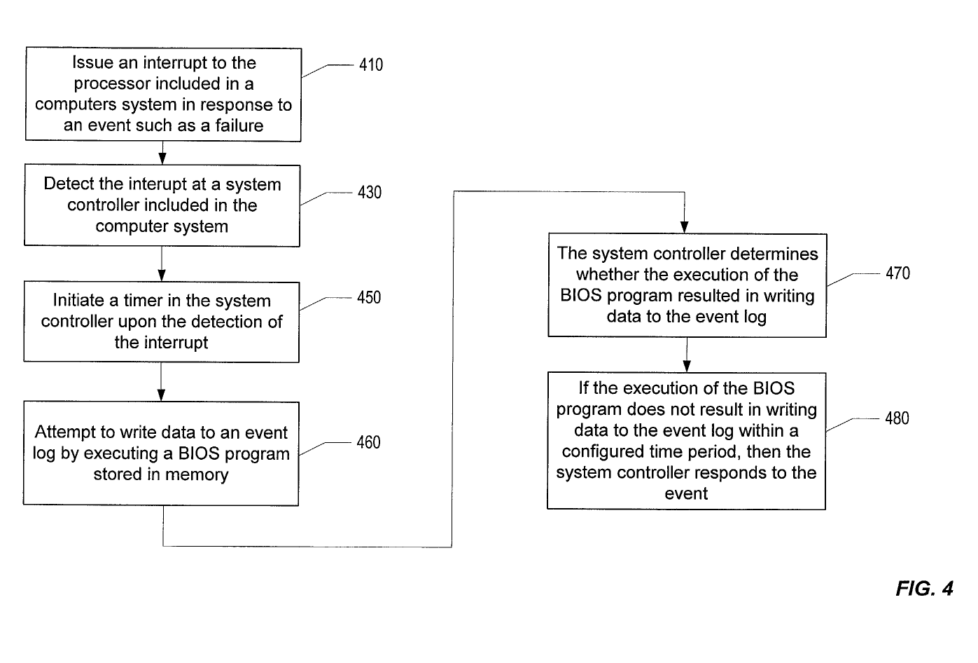

Referring to FIG. 4, flow chart shows an embodiment of a method for responding to an event associated with the computer system 100 illustrated in FIG. 1. In this embodiment, the occurrence of the event, such as a failure of the computer system 100, is detected and an interrupt signal, e.g., SMI, is issued to the processor 105 in step 410. In step 430, the system controller 192 detects the interrupt signal. In step 440, in response to detecting the interrupt signal the system controller initiates timer 193, e.g., a watchdog timer. In step 450, a BIOS program is executed in response to the interrupt signal. The purpose of executing the BIOS program is to read data describing the event, e.g., failure data stored in PCI configuration registers, and describe the event by writing to an event log. The BIOS program attempts to read data describing the event and subsequently write data to an event log. In step 460, the system controller 192 determines whether the execution of the BIOS program resulted in the writing of data to the event log. In step 470, if the system controller 192 determines that the execution of the BIOS did not result in the writing of the data to the event log before expiration of a time period established by timer 193 then the system controller 192 responds to the event. For example, if the execution of the BIOS program causes the second failure described earlier then the BIOS program would not be able to be completed, e.g., would be unable to write data to the event log before expiration of the timer 193. The system controller 192 responds by reading data describing the event and subsequently writing data to an event log, in step 480.

Although the method and system of the present invention has been described in connection with the preferred embodiment, it is intended to cover such alternatives, modifications, and equivalents, as can be reasonably included within the spirit and scope of the invention as defined by the appended claims. For example, an operating system independent method of accessing and writing event log data on a failure of computer system 100 may be implemented in a device other than system controller 192.

What is claimed is:

1. In a system management controller included in a computer system, a method of accessing event data describing a failure, the method comprising:
configuring the system management controller to monitor a task of writing data to an event log, the task being executed by a Basic Input Output System (BIOS) program in response to the failure;
monitoring the task for completion;
accessing the event data if the task fails to complete.

2. The method of claim 1, wherein the failure generates a system management interrupt and the BIOS program is triggered in response to the system management interrupt.

3. The method of claim 1, wherein monitoring the task comprises:
setting a configurable time of a watchdog timer, the task being configured to access the event data, and write the data to the event log in response to the event data, the task being completed within the configurable time set in the watchdog timer;
receiving an indication from the BIOS program on completion of the task.

4. The method of claim 3, wherein the task fails to complete when the task fails to receive the indication from the BIOS program.

5. The method of claim 3, wherein receiving the indication from the BIOS program comprises resetting the configurable time in the watchdog timer.

6. The method of claim 1, wherein the event data is stored in a memory of the computer system by a controller device included in the computer system.

7. The method of claim 6, wherein the controller device is a memory controller.

8. The method of claim 6, wherein the controller device is an I/O controller.

9. The method of claim 1, wherein the system management controller accesses the event data over a system bus of the computer system.

10. The method of claim 9, wherein the system bus is a SMbus.

11. The method of claim 1 further comprising, the system management controller writing the event log in response to accessing the event data.

12. The method of claim 11, wherein writing the event log occurs over a system bus of the computer system.

13. The method of claim 12, wherein the system bus is a SMbus.

14. A method of accessing event data on a failure of a computer system, the method comprising:
executing a BIOS program to access the event data in response to a first failure of the computer system;
triggering a watchdog timer in a system management controller of the computer system, the watchdog timer being triggered substantially concurrent to the first failure;
configuring the watchdog timer to allow the BIOS program to complete in absence of a second failure;
determining whether the execution of the BIOS program caused the second failure, the second failure forcing the watchdog timer to expire; and
the system management controller accessing the event data when the watchdog timer expires.

15. The method of claim 14, wherein the second failure is substantially similar to the first failure.

16. The method of claim 14, wherein the second failure occurs while a processor included in the computer system operates in a SMM mode.

17. A computer system comprising:
a processor;
a memory coupled to the processor;
a BIOS program stored in the memory, the BIOS program being operable to write data to an event log in response to a critical event;
a system controller coupled to the memory and the processor, the system controller operable to:
receive an indication of the critical event;
upon receipt of the indication, initiate operation of a timer; and
determine whether the BIOS program has written the data to the event log within a configurable period of time defined by the timer.

18. In a computer system having a processor and a system controller, a method of responding to an event, the method comprising:
issuing an interrupt to the processor in response to the event;
detecting the interrupt at the system controller coupled to the processor;
initiating a timer in the system controller upon detection of the interrupt;
attempting to write data to an event log by executing a BIOS program;
the system controller determining whether the execution of the BIOS program resulted in writing data to the event log.

19. The method of claim 18 further comprising:
if execution of the BIOS does not result in the writing of the data to the event log before expiration of a time period established by the timer, causing the system controller to respond to the event.
